(19) United States
(12) Patent Application Publication
(10) Pub. No.: US 2020/0154197 A1
(43) Pub. Date: May 14, 2020

(54) ACOUSTIC PROCESSOR AND ACOUSTIC OUTPUT DEVICE

(71) Applicant: SOCIONEXT INC., Kanagawa (JP)

(72) Inventor: Shuji MIYASAKA, Yokohama (JP)

(21) Appl. No.: 16/740,244

(22) Filed: Jan. 10, 2020

Related U.S. Application Data
(63) Continuation of application No. PCT/JP2017/026165, filed on Jul. 19, 2017.

(51) Int. Cl. H04R 1/22; H04R 1/26

(52) U.S. Cl. CPC H04R 1/227; H04R 2430/20; H04R 2217/03; H04R 1/26

(57) ABSTRACT

An acoustic processor includes: an oversampler that oversamples an acoustic signal that is a digital signal including a frequency component less than or equal to Fh, where Fh is a preset frequency, and having a sampling frequency of Fs, into a signal having a sampling frequency greater than or equal to 2Fs; a modulator that modulates an ultrasound signal having a frequency Fc greater than or equal to 2Fh as a carrier wave using the acoustic signal; an acoustic output terminal; and an adder that adds an output signal from the oversampler and an output signal from the modulator and outputs a resultant sum to the acoustic output terminal.

### CROSS REFERENCE TO RELATED APPLICATION

This is a continuation application of PCT Patent Application No. PCT/JP2017/026165 filed on Jul. 19, 2017, designating the United States of America. The entire disclosure of the above-identified application, including the specification, drawings and claims is incorporated herein by reference in its entirety.

### FIELD

The present disclosure relates to an acoustic processor that processes an acoustic signal and to an acoustic output device that outputs sound.

### BACKGROUND

In recent years, there has been a tendency for bodies of television sets (hereinafter also simply called “televisions”) to be designed with emphasis on thinness or with emphasis on aesthetics, and in most cases speakers are installed so as to face downward so as to emit sound toward a lower surface of a television panel. In that case, sound that is emitted downward from the speaker reflects on an upper surface of a base on which the television is placed, diffuses, and does not have any directivity.

At the same time, a sound reproduction technique has been proposed conventionally having sharp directivity that uses an ultrasound speaker. By modulating an ultrasound signal as a carrier wave using an audible-bandwidth signal, this technique plays undulation of the sound wave according to a sideband wave and the carrier wave that are generated thereby, and provides a listener with sound having sharp directivity that accompanies rectilinear propagation properties that are inherent in the ultrasound signal. Patent Literature 1 discloses a method for reproducing voice explanations for a plurality of products displayed on shop shelves by directional reproduction that uses ultrasound so as not to interfere with each other.

### CITATION LIST

### Patent Literature

[Patent Literature 1]

International Publication No. WO2012/157219

### SUMMARY

### Technical Problem

However, as has been mentioned above, sound that results from audio signals that are emitted downward from the lower surface of the television panel being reflected on an upper surface of a television stand has very little directivity, and disperses in all directions. Consequently, in order to prevent sound from leaking to neighboring rooms at night, for example, the only recourse has been to reduce the volume of the emitted sound. Furthermore, even in such cases where sounds emitted for specific listeners, such as commentary sound for visually impaired people, are comfortable for unimpaired people who are simultaneously trying before buying, it has not been possible to impart directivity only to such specific sounds.

Now, in order to emit sound having sharp directivity, it is conceivable that the above-mentioned directional reproduction technique could be built into a television to reproduce that output signal using an ultrasound speaker. However, because a directional speaker must be disposed so as to directly face the listener who wants to hear that sound, the modern aesthetic design of the television body (an external appearance that hides the speaker) would be lost.

In order to avoid that, it is conceivable to make the directional speaker detachable, and maintain an external appearance that is similar or identical to the conventional one by not connecting the directional speaker to the television when directional reproduction is not required, and to perform normal bandwidth reproduction and directional reproduction without losing the aesthetic design of the television body.

However, because audio terminals that can output ultrasound signals are not included in conventional televisions, it is necessary to dispose a dedicated audio terminal that outputs ultrasound signals separately in addition to audio terminals for connecting headphones and external speakers.

An object of the present disclosure is to provide an acoustic processor that can perform conventional audible-bandwidth acoustic reproduction and acoustic reproduction with directivity without having to dispose a dedicated audio terminal that outputs ultrasound signals. Another object of the present disclosure is to provide an acoustic output device that can also perform directional reproduction without losing aesthetic design.

### Solution to Problem

In order to achieve the above objective, an acoustic processor according to one aspect of the present disclosure includes: an oversampler that oversamples an acoustic signal that is a digital signal including a frequency component less than or equal to Fh, where Fh is a preset frequency, and having a sampling frequency of Fs, into a signal having a sampling frequency greater than or equal to 2Fs; a modulator that modulates an ultrasound signal having a frequency Fc greater than or equal to 2Fh as a carrier wave using the acoustic signal; an acoustic output terminal; and a selector that selects at least one signal from an output signal from the oversampler and an output signal from the modulator to output to the acoustic output terminal.

In order to achieve the above objective, an acoustic output device according to another aspect of the present disclosure includes: an audible-bandwidth speaker that outputs audible-bandwidth sound vertically; and an ultrasound speaker that outputs sound horizontally using ultrasonic waves.

Moreover, these overall or specific aspects may be implemented using systems, methods, integrated circuits, computer programs, or recording media such as computer-readable CD-ROMs, or may be implemented using any combination of systems, methods, integrated circuits, computer programs, or recording media.

### Advantageous Effects

According to the present disclosure, an acoustic processor can be achieved that can perform conventional audible-bandwidth acoustic reproduction and acoustic reproduction with directivity without having to dispose a dedicated audio terminal that outputs ultrasound signals. An acoustic output device can also be achieved that can also perform directional reproduction without losing aesthetic design.

### BRIEF DESCRIPTION OF DRAWINGS

These and other objects, advantages and features of the disclosure will become apparent from the following description thereof taken in conjunction with the accompanying drawings that illustrate specific embodiments of the present disclosure.

FIG. 1 is a block diagram that shows a configuration example of an acoustic processor according to Embodiment 1.

FIG. 2 is a diagram that shows relationships among upper limit frequency Fh, sampling frequency Fs, and Nyquist frequency Fn.

FIG. 3 is a timing chart that shows a signal example for explaining operation of an oversampler.

FIG. 4 is a diagram that shows frequency components of an output signal from the oversampler.

FIG. 5 is a timing chart that shows a signal example for explaining operation of a modulator.

FIG. 6 is a diagram that shows frequency components of an output signal from the modulator.

FIG. 7 is a diagram that shows frequency components of an output signal from an adder.

FIG. 8 is a diagram that shows that an output signal from the acoustic processor can be used with both an audible-bandwidth speaker and an ultrasound speaker.

FIG. 9 is a block diagram that shows a configuration example of an acoustic processor according to Variation 1 of Embodiment 1.

FIG. 10 is a block diagram that shows a configuration example of an acoustic processor according to Variation 2 of Embodiment 1.

FIG. 11 is a block diagram that shows a configuration example of an acoustic processor according to Variation 3 of Embodiment 1.

FIG. 12 is an external view of an acoustic output device according to Embodiment 2.

FIG. 13 is a block diagram that shows a configuration example of an acoustic output device according to the present embodiment.

### DESCRIPTION OF EMBODIMENTS

Preferred embodiments of the present disclosure will now be explained in detail using the drawings. Moreover, the preferred embodiments that are explained below each represent one specific example of the present disclosure. Numerical values, shapes, components, positions of disposition and connection forms of the components, signal waveforms, processing procedures, etc., that are disclosed in the embodiments below are examples only, and are not intended to limit the present disclosure in any way. Furthermore, among the components in the embodiments below, components that are not described in the independent claims, which represent the most significant concepts according to the present disclosure, are explained as optional components. Furthermore, the respective drawings are not necessarily depicted exactly. In each of the figures, configurations that are substantially identical shall be allotted identical numbering, and duplicate explanations shall be omitted or simplified.

### Embodiment 1

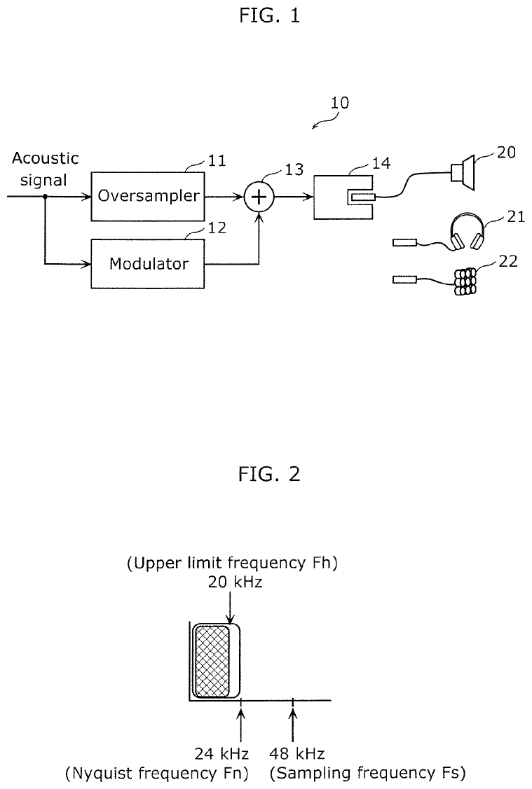

FIG. 1 is a block diagram that shows a configuration example of an acoustic processor 10 according to Embodiment 1.

The acoustic processor 10 is a signal processing device that processes acoustic signals to output an audible-bandwidth acoustic signal and an ultrasound signal including the acoustic signal, and includes an oversampler 11, a modulator 12, an adder 13, and an acoustic output terminal 14. Moreover, an audible-bandwidth speaker 20, headphones 21, and an ultrasound speaker 22 are all depicted together in this figure as speakers that can be connected to the acoustic output terminal 14. Moreover, the “acoustic signal” is not only a voice signal, but is a wider signal that includes all types of sound such as musical instruments, etc.

The acoustic signal that is inputted is a digital signal including frequency components that are less than or equal to Fh, where Fh is a preset frequency, and having a sampling frequency Fs (hereinafter Fh is also called an “upper limit frequency”). The upper limit frequency Fh is an upper limit value for major frequency components in human hearing, specifically a value greater than or equal to 14 kHz and less than or equal to 24 kHz, and in the present embodiment is 20 kHz. The sampling frequency Fs is 48 kHz, which has been standardized as the sampling frequency for audio signals in major media such as digital television broadcasting, digital versatile discs (DVDs), Blu-ray® discs (BDs), for example. An acoustic signal having a sampling frequency Fs of 48 kHz can include signal components up to 24 kHz, which is the Nyquist frequency Fn of the sampling frequency Fs. Relationships among the upper limit frequency Fh, the sampling frequency Fs, and the Nyquist frequency Fn are as shown in FIG. 2.

Moreover, because there are individual differences in the upper limit frequency Fh and it also decreases due to aging, the upper limit frequency Fh may alternatively be set to 17 kHz or 14 kHz, depending on the application. In other words, the sampling frequency Fs and the Nyquist frequency Fn are frequencies that are determined as standards in equipment that provides the input signal to the acoustic processor 10 according to the present disclosure, whereas the upper limit frequency Fh is a frequency that is determined specifically for the acoustic processor 10 according to the present embodiment (by usefulness from application and design perspectives, etc.)

The oversampler 11 is a signal processor that oversamples the inputted acoustic signal into a signal having a sampling frequency greater than or equal to 2Fs. In the present embodiment, the oversampler 11 oversamples the inputted acoustic signal to a signal having a sampling frequency Fs of 192 kHz.

The modulator 12 is a signal processor that modulates an ultrasound signal having a frequency Fc greater than or equal to 2Fh as a carrier wave using the inputted acoustic signal. In the present embodiment, the modulator 12 oversamples the inputted acoustic signal to a quadruple sampling frequency Fs, and uses the obtained signal as a modulating signal to amplitude modulate an ultrasound signal having a frequency Fc of 40 kHz.

The adder 13 is a signal processor that adds together the output signal from the oversampler 11 and the output signal from the modulator 12, and outputs a resultant sum to the acoustic output terminal 14. Moreover, this adder 13 is an example of a selector that selects at least one signal from the output signal from the oversampler 11 and the output signal from the modulator 12 to output to the acoustic output terminal 14.

The acoustic output terminal 14 is a terminal that outputs the output signal from the adder 13, the audible-bandwidth speaker 20, the headphones 21, or the ultrasound speaker 22 being selectively connected to the acoustic output terminal 14. The audible-bandwidth speaker 20 is a generally commercially available speaker for use in audible bandwidths. The headphones 21 are generally commercially available headphones, and may be in-ear headphones. The ultrasound speaker 22 is a speaker that emits ultrasound, and may be a “parametric speaker”, in which a plurality of transducers that can emit ultrasound are disposed plurally in a plane.

Moreover, the oversampler 11, the modulator 12, and the adder 13 may be implemented as software using a read-only memory (ROM) on which a program is stored, a random-access memory (RAM) that temporarily holds data, and a processor that executes the program, etc., or may be implemented as hardware using digital signal processing circuits such as digital filters, a digital adder, etc.

Next, operation of the acoustic processor 10 according to the present embodiment, which is configured in the above manner, will be explained.

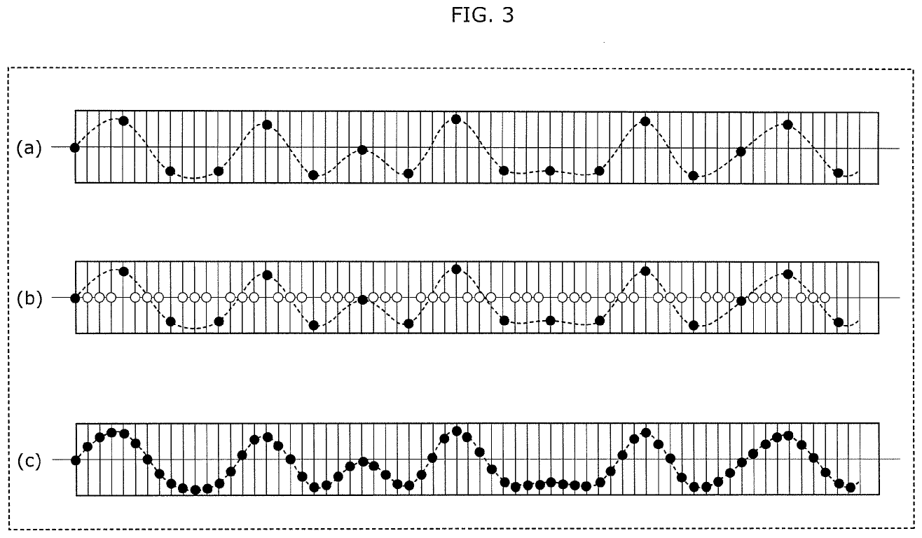

In FIG. 3, (a) through (c) are timing charts that show signal examples for explaining operation of the oversampler 11. More specifically, in FIG. 3, (a) shows an example of an acoustic signal that is inputted into the oversampler 11, (b) shows an example of a signal during an intermediate process in the oversampler 11, and (c) shows an example of an output signal from the oversampler 11.

The oversampler 11 first generates a signal having quadruple sample size by inserting into an input signal such as that shown in FIG. 3A, that is, into an acoustic signal having a sampling frequency Fs of 48 kHz, three samples that have an amplitude of zero between each of the samples of the acoustic signal, as shown in FIG. 3B. Next, the oversampler 11 generates an output signal having a sampling frequency Fs of 192 kHz such as that shown in FIG. 3C by applying a 24 kHz low-pass filter to the generated signal. By removing high-end distortion components from the signal that has been interpolated using samples that have zero amplitude using a low-pass filter having a cutoff frequency of 24 kHz, which is the Nyquist frequency of the original acoustic signal in this manner, a smoothly interpolated signal having a sampling frequency Fs of 192 kHz can be generated. Moreover, the oversampling processing that is shown in FIG. 3 is only an example, and other methods may alternatively be used.

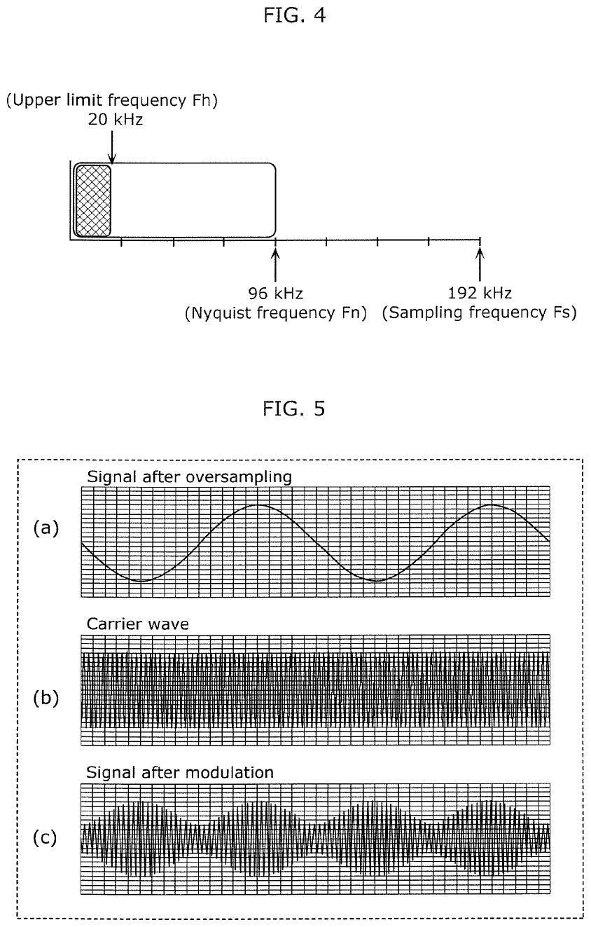

FIG. 4 is a diagram that shows frequency components of the output signal from the oversampler 11. As shown in this figure, the output signal from the oversampler 11 is a signal having a sampling frequency Fs of 192 kHz, but includes major frequency components for audibility in a bandwidth less than or equal to the upper limit frequency Fh (here, 20 kHz).

In FIG. 5, (a) through (c) are timing charts that show signal examples for explaining operation of the modulator 12. More specifically, in FIG. 5, (a) shows an example of a signal during an intermediate process in the modulator 12 (a signal having a sampling frequency Fs of 192 kHz), (b) shows an example of an ultrasound signal that functions as a carrier wave that is used in the modulation (a 40 kHz sine wave relative to the sampling frequency of 192 kHz), and (c) shows an example of an output signal (that is, a modulated signal) from the modulator 12.

The modulator 12 first generates a signal having a sampling frequency Fs of 192 kHz, such as that shown in FIG. 5A, by performing quadruple oversampling on the inputted acoustic signal, which has a sampling frequency Fs of 48 kHz. Next, the modulator 12 uses the signal that is obtained from the oversampling as a modulating signal to generate a modulated signal such as that shown in FIG. 5C by amplitude modulating the 40 kHz sine wave (ultrasound signal) that is shown in FIG. 5B as the carrier wave.

Now, the carrier frequency Fc is set to a value greater than or equal to double the upper limit frequency Fh. In the present embodiment, because the upper limit frequency Fh has been set to 20 kHz, the frequency Fc of the carrier wave has been set to 40 kHz. Here, the carrier frequency Fc is not limited to 40 kHz, and may alternatively be a value greater than 40 kHz. Furthermore, if the upper limit frequency Fh is considered to be 14 kHz, that is, if intended for users who are not expected to be able to hear frequency components that are greater than or equal to 14 kHz, or if the inputted acoustic signal is a signal to which a low-pass filter having a cutoff frequency of 14 kHz has been applied, or if a low-pass filter having a cutoff frequency of 14 kHz is applied to the inputted acoustic signal, for example, then the carrier frequency Fc may alternatively be set to 28 kHz.

The simplest method of modulation by the modulator 12 is multiplying the signal that is shown in FIG. 5A and the carrier wave that is shown in FIG. 5B. However, the method of modulation may alternatively be any other kind of method.

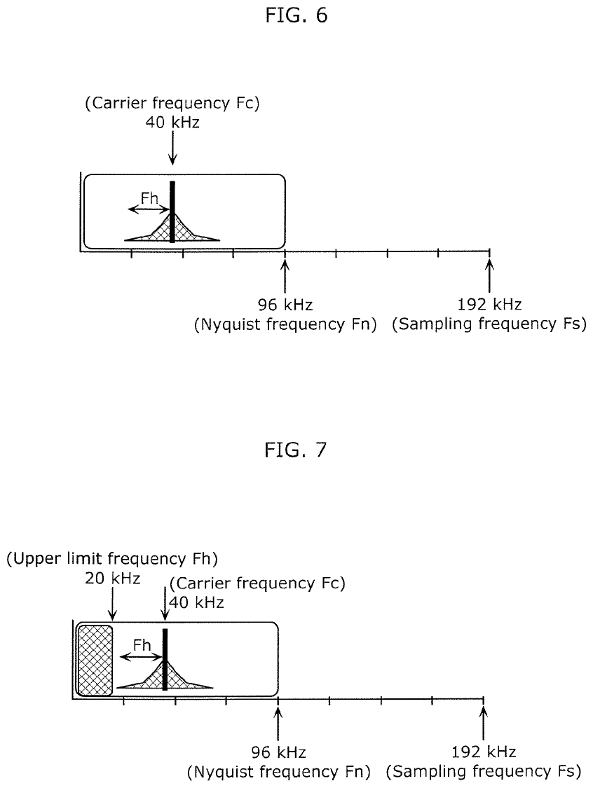

FIG. 6 is a diagram that shows frequency components of an output signal from the modulator 12. As shown in this figure, in the output signal from the modulator 12, major frequency components of the inputted acoustic signal (frequency components that are less than or equal to the upper limit frequency Fh) are included in a side band having a carrier frequency of 40 kHz. In other words, the modulated signal (the sideband wave) exists in a range of the carrier frequency Fc±Fh. Moreover, in FIG. 6, the sideband wave exists to the left and right (a low band component and the high band component) of the carrier wave, but may alternatively be modulated such that only the low band component is generated, or may alternatively be modulated such that only the high band component is generated, or may alternatively be modulated such that at least one of the low band component and the high band component is generated selectively depending on the frequency components of the signal before modulation.

Moreover, either the processing in the oversampler 11 or the processing in the modulator 12 may be first, or they may alternatively be simultaneous.

Next, the adder 13 adds the output signal from the oversampler 11 and the output signal from the modulator 12. Specifically, because the output signal from the oversampler 11 and the output signal from the modulator 12 are both signals that have a sampling frequency Fs of 192 kHz, the adder 13 adds the amplitude of the corresponding samples in those two signals.

FIG. 7 is a diagram that shows frequency components of an output signal from the adder 13. A point that should be noted here is that because the carrier frequency Fc was set to greater than or equal to 2Fh, as described above, the major frequency components for audibility that are included in the inputted acoustic signal and the sideband wave of the signal after modulation do not overlap with each other. Thus, the major component of the original acoustic signal and the ultrasound signal after modulation are in a state in which they will not interfere with each other.

The output signal from the adder 13 is inputted into the acoustic output terminal 14. The acoustic output terminal 14 may be adapted to a widely commercially available audio mini-jack. An audible-bandwidth speaker 20 may be connected to the acoustic output terminal 14, or headphones 21 may be connected, or an ultrasound speaker 22 may be connected. Here, it goes without saying that the audible-bandwidth speaker 20, the headphones 21, and the ultrasound speaker 22 have filters or amplifiers that depend on their respective characteristics built-in or as accessories.

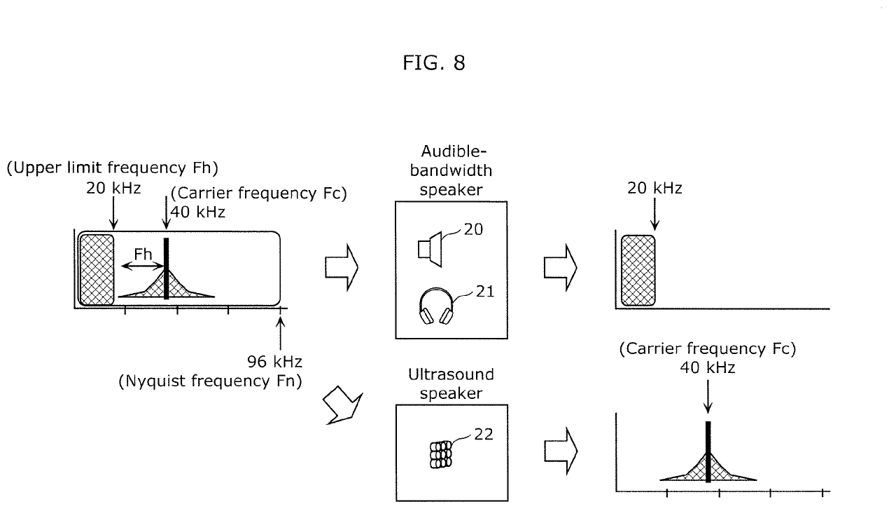

FIG. 8 is a diagram that shows that the output signal from the acoustic processor 10 according to the present embodiment can be used with both an audible-bandwidth speaker (the audible-bandwidth speaker 20 and the headphones 21) and an ultrasound speaker 22. As shown in this figure, the major frequency components for audibility in the original acoustic signal and the ultrasound waveband carrier frequency components that have been modulated by the acoustic signal exist in the output signal from the acoustic processor 10 without interfering with each other. Consequently, if an audible-bandwidth speaker that can only reproduce audible-bandwidth (the audible-bandwidth speaker 20 or the headphones 21) is connected to the acoustic output terminal 14, then only the original acoustic signal is reproduced without the ultrasound component being reproduced. If, on the other hand, the ultrasound speaker 22 is connected to the acoustic output terminal 14, then because the ultrasound speaker 22 can reproduce only the signal in the ultrasound waveband, and people cannot hear the ultrasound component, only undulation of the ultrasound component, that is, audible-bandwidth sound, can be heard by people. As mentioned above, because the ultrasound waveband signal that the ultrasound speaker 22 reproduces is an ultrasound signal that has been modulated by an audible-bandwidth acoustic signal, undulation of the sound wave by the carrier wave and the sideband wave arises using the ultrasound speaker 22, and sound having sharp directivity is reproduced due to the rectilinear propagation properties of the ultrasound signal.

In the above manner, the acoustic processor 10 according to the present embodiment includes: an oversampler 11 that oversamples an acoustic signal into a signal having a sampling frequency greater than or equal to 2Fs, the acoustic signal being a digital signal including frequency components that are less than or equal to Fh, where Fh is a preset frequency having a sampling frequency of Fs; a modulator 12 that modulates an ultrasound signal having a frequency Fc greater than or equal to 2Fh as a carrier wave using the acoustic signal; an acoustic output terminal 14; and a selector (in this case, the adder 13) that selects at least one signal from the output signal of the oversampler 11 and the output signal of the modulator 12 to output to the acoustic output terminal 14.

Thus, because at least one signal from the audible-bandwidth acoustic signal and the ultrasound signal is selected and outputted through a single acoustic output terminal 14, conventional audible-bandwidth acoustic reproduction and acoustic reproduction with directivity can be performed without having to dispose a dedicated audio terminal that outputs ultrasound signals.

In the present embodiment, the above selector is an adder 13 that adds together the output signal from the oversampler 11 and the output signal from the modulator 12, and outputs the sum to the acoustic output terminal 14.

Because the audible-bandwidth acoustic signal and the ultrasound signal are added and outputted through the acoustic output terminal 14, conventional audible-bandwidth acoustic reproduction and acoustic reproduction with directivity can be performed selectively according to the type of speaker that is connected to the acoustic output terminal 14. In other words, conventional audible-bandwidth sound reproduction and sound reproduction with directivity can be performed using a single signal, enabling audible-bandwidth speakers (the audible-bandwidth speaker 20 and the headphones 21) and the ultrasound speaker 22 to be used detachably in a shared acoustic output terminal 14.

### Variation 1

Next, an acoustic processor according to Variation 1 of Embodiment 1 will be explained.

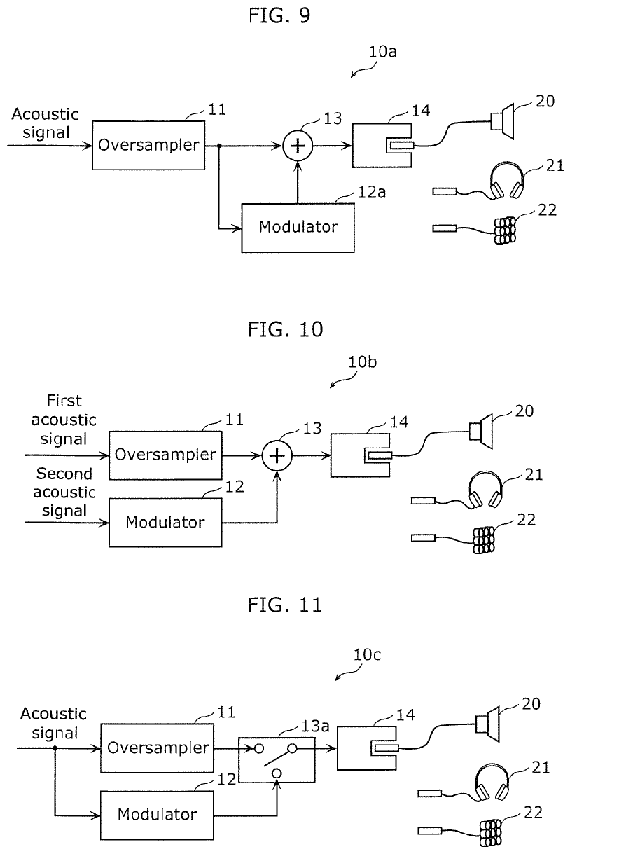

FIG. 9 is a block diagram that shows a configuration example of an acoustic processor according to Variation 1 of Embodiment 1. This acoustic processor 10a corresponds to a construction in which the modulator 12 in the acoustic processor 10 according to Embodiment 1 is replaced with a new modulator 12a.

The modulator 12a does not use an acoustic signal that has been inputted to the acoustic processor 10a, but rather uses an output signal from the oversampler 11 to modulate an ultrasound signal as a carrier wave. In Embodiment 1, in order to generate the signal having a sampling frequency Fs of 192 kHz that is shown in FIG. 5A, the modulator 12 performed quadruple oversampling on the acoustic signal that was inputted to the acoustic processor 10. In the present variation, the modulator 12a omits oversampling processing by using the output signal from the oversampler 11 as an input signal. In other words, the modulator 12a uses the output signal from the oversampler 11 as a modulating signal to generate the modulated signal that is shown in FIG. 5C by performing modulation on the ultrasound signal that is shown in FIG. 5B as the carrier wave.

Thus, the modulator 12a according to the present variation uses an output signal from the oversampler 11 to modulate an ultrasound signal as a carrier wave. The oversampler 11 is thereby used not only for oversampling for generating the audible-bandwidth signal, but also for preprocessing of modulation by the modulator 12, enabling the processing in the modulator 12a to be simplified.

### Variation 2

Next, an acoustic processor according to Variation 2 of Embodiment 1 will be explained.

FIG. 10 is a block diagram that shows a configuration example of an acoustic processor 10b according to Variation 2 of Embodiment 1. This acoustic processor 10b corresponds to a configuration in which the acoustic signal that is inputted into the oversampler 11 and the modulator 12 in the acoustic processor 10 according to Embodiment 1 is separated into separate acoustic signals (a first acoustic signal and a second acoustic signal, respectively).

In other words, the oversampler 11 oversamples the first acoustic signal into a signal having a sampling frequency greater than or equal to 2Fs. The modulator 12 uses the second acoustic signal to modulate an ultrasound signal having a frequency Fc greater than or equal to 2Fh as a carrier wave.

Here, the first acoustic signal is an audio signal (the main sound) of a main part of a television broadcast, for example, whereas the second acoustic signal may be an auxiliary sound associated with the broadcast in question, or may alternatively be commentary sound for visually impaired people. Alternatively, the first acoustic signal is the primary audio in the Blu-ray Disc standards, whereas the second acoustic signal may be a secondary audio that is associated therewith.

It thereby becomes possible to perform conventional audible-bandwidth acoustic reproduction on one of two types of acoustic signal, such as the main sound and the auxiliary sound, and perform acoustic reproduction with directivity on the remaining type, improving audiovisual usefulness for a plurality of viewers including both visually impaired people and unimpaired people.

Variation 3 Next, an acoustic processor according to Variation 3 of Embodiment 1 will be explained.

FIG. 11 is a block diagram that shows a configuration example of an acoustic processor 10c according to Variation 3 of Embodiment 1. This acoustic processor 10c corresponds to a construction in which the adder 13 in the acoustic processor 10 according to Embodiment 1 is replaced with a switch 13a.

The switch 13a is a device that selects one signal from the output signal from the oversampler 11 and the output signal from the modulator 12, and outputs it to the acoustic output terminal 14, and is constituted by a mechanical changeover switch or a semiconductor switch, for example. Moreover, this switch 13a is an example of a selector that selects at least one signal from the output signal from the oversampler 11 and the output signal from the modulator 12 to output to the acoustic output terminal 14.

The switching control of the switch 13a may be switching over interdependently with manual operation by a switch such as a button or a dial, etc., that is disposed on the acoustic processor 10c, or may alternatively be switching over automatically in response to the type of speaker or headphones that is connected to the acoustic output terminal 14. For example, the switch 13a distinguishes the type of speaker or headphones that is connected by the presence or absence of the specific connecting pin for the speaker or headphones that is inserted into the acoustic output terminal 14 or by a voltage, etc., and as a result of that, switches such that the output signal from the oversampler 11 is outputted to the acoustic output terminal 14 if it is detected that an audible-bandwidth speaker (the audible-bandwidth speaker 20 or the headphones 21) is connected, and switches such that the output signal from the modulator 12 is outputted to the acoustic output terminal 14 if, on the other hand, it is detected that the ultrasound speaker 22 is connected.

Thus the selector according to the present variation is a switch 13a that selects one signal from the output signal from the oversampler 11 and the output signal from the modulator 12, and outputs it to the acoustic output terminal 14.

Because the audible-bandwidth acoustic signal and the ultrasound signal including the acoustic signal are selectively outputted through the acoustic output terminal 14, conventional audible-bandwidth acoustic reproduction and acoustic reproduction with directivity can be performed selectively by switching over the selector.

### Embodiment 2

Next, an acoustic processor according to Embodiment 2 will be explained.

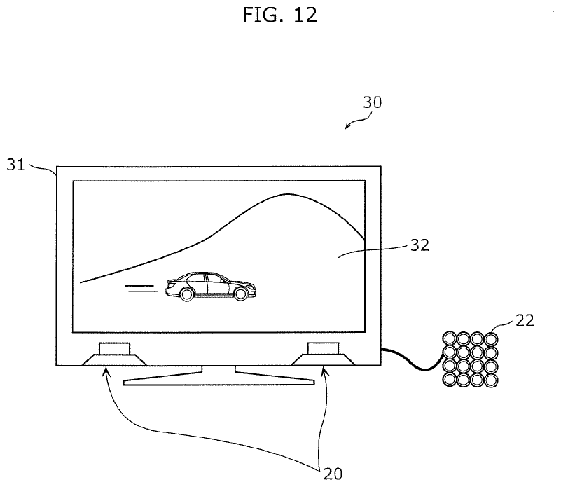

FIG. 12 is an external view of an acoustic output device 30 according to Embodiment 2.

The acoustic output device 30 includes as characteristic components: audible-bandwidth speakers 20 that output audible-bandwidth sound vertically; and an ultrasound speaker 22 that outputs sound horizontally using ultrasonic waves. Moreover, in the present embodiment, an example is shown in which the acoustic output device 30 is applied to a television, and an acoustic output device 30 is depicted that includes: a housing 31 that incorporates a display 32 and the audible-bandwidth speakers 20; and the ultrasound speaker 22.

The audible-bandwidth speakers 20 are fixed inside the housing 31. Moreover, the shapes of the audible-bandwidth speakers 20 appear to be exposed on a front surface for the purpose of explanation in FIG. 12, but because they are in fact mounted internally into the housing 31, they are not visible from the front. These audible-bandwidth speakers 20 are disposed facing downward on a lower surface of the housing 31 from a viewpoint of emphasis on aesthetic design of the television body.

The ultrasound speaker 22 is detachably connected to an acoustic output terminal that is disposed on the housing 31, and is disposed so as to emit sound horizontally. This is in order to provide a signal having strong directivity using ultrasonic waves so as to be directed toward a listener who is facing the television screen directly. The listener in question is a listener who requires commentary sound for visually impaired people, for example. Moreover, the ultrasound speaker 22 may also be fixed inside the housing 31, or may alternatively be mounted to the housing 31 in a detachable form.

By adopting a configuration of this kind, the aesthetic design of the television body is not lost, yet if directional sound is required, sound having strong directivity can be provided to a specific listener by connecting the ultrasound speaker to the acoustic output terminal that is included in a conventional television, such as a headphone output terminal, etc.

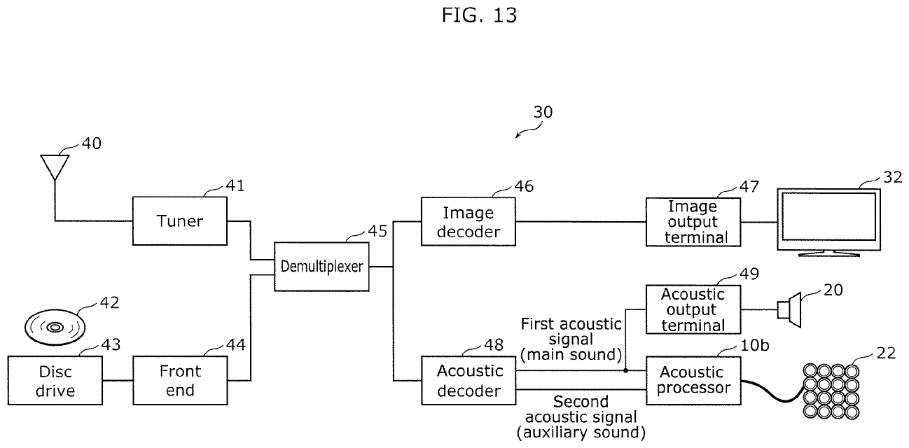

FIG. 13 is a block diagram that shows a configuration example of the acoustic output device 30 according to the present embodiment.

The acoustic output device 30 includes: an antenna 40, a tuner 41, a disk 42, a disc drive 43, a front end 44, a demultiplexer 45, an image decoder 46, an image output terminal 47, an acoustic decoder 48, an acoustic output terminal 49, a display 32, an acoustic processor 10b, and an ultrasound speaker 22.

The antenna 40 is a television broadcast receiving antenna, and is a parabolic antenna, for example. Moreover, if the acoustic output device 30 receives television broadcasts by cable, as in the case of cable television, etc., the antenna 40 may alternatively be a receiver or a connector that is connected to the cable that distributes the television broadcasts.

The tuner 41 is a tuner for television broadcasts, and may be a type that is built into the housing 31, or may alternatively be a type that is installed outside the housing 31 such as a set-top box.

The disk 42 is a recording medium for video recording and playback, and is a DVD or a BD, for example.

The disc drive 43 is a drive device that records video content to the disk 42, and plays back video content that is recorded on the disk 42, etc., and may be a type that is built into the housing 31, or may alternatively be a type that is installed outside the housing 31 such as a stand-alone BD recorder.

The front end 44 is a circuit that demodulates the signal that is retrieved from the disk 42 and performs signal processing such as error correction, etc.

The demultiplexer 45 is a circuit that demultiplexes the video stream that has been outputted from the tuner 41 or the front end 44 into an image stream and a sound stream, and outputs them to the image decoder 46 and the acoustic decoder 48, respectively.

The image decoder 46 is a circuit that decodes and outputs the encoded image stream that has been outputted from the demultiplexer 45.

The image output terminal 47 is a circuit that shapes the image stream that has been outputted from the image decoder 46 into a waveform and outputs it as an image signal.

The display 32 is the display panel that displays the image signals that have been outputted from the image output terminal 47, and is a liquid crystal display (LCD), for example.

The acoustic decoder 48 is a circuit that decodes the encoded acoustic stream that is outputted from the demultiplexer 45, and separates and outputs it into a first acoustic signal (here, a main sound signal) and a second acoustic signal (here, the auxiliary sound signal). Moreover, this acoustic decoder 48 is an example of an acoustic signal obtainer that obtains an acoustic signal that is a digital signal including frequency components that are less than or equal to Fh, where Fh is a preset frequency, and having a sampling frequency of Fs.

The acoustic output terminal 49 is a circuit that converts and amplifies, etc., the first acoustic signal that is outputted from the acoustic decoder 48 into an analog signal.

The audible-bandwidth speakers 20 are speakers that output audible-bandwidth sound by reproducing the first acoustic signal that is outputted from the acoustic output terminal 49, and are disposed so as to face downward on a lower surface of the housing 31, as described above. In other words, the audible-bandwidth speakers 20 are connected to the acoustic signal obtainer (here, connected to the acoustic decoder 48 by means of the acoustic output terminal 49) such that the acoustic signal (here, the first acoustic signal) that is obtained by the acoustic signal obtainer is inputted to the audible-bandwidth speakers 20.

The acoustic processor 10b is an acoustic processor according to Variation 2 of Embodiment 1 above, and oversamples the first acoustic signal that is outputted from the acoustic decoder 48, and also uses the second acoustic signal that is outputted from the acoustic decoder 48 to modulate an ultrasound signal as a carrier wave, adds the two signals that are obtained, and outputs them through the acoustic output terminal 14.

The ultrasound speaker 22 is connected to the acoustic output terminal 14 of the acoustic processor 10b when required, and is disposed so as to emit sound horizontally, as described above. Specifically, the ultrasound speaker 22 is connected to the acoustic processor 10b (here, connected to the acoustic output terminal 14 of the acoustic processor 10b) such that the output signal from the selector (here, the adder 13) of the acoustic processor 10b is inputted to the ultrasound speaker 22.

Thus, in the acoustic output device 30 according to the present embodiment, because the audible-bandwidth speakers 20 that are built into the housing 31 are connected to the acoustic decoder 48 by means of the acoustic output terminal 49, and the ultrasound speaker 22, on the other hand, is connected to the acoustic output terminal 14 of the acoustic processor 10b, the main sound is emitted non-directionally, and the auxiliary sound is emitted with directivity so as to be directed toward a specific listener, without losing the aesthetic design of the television body.

The auxiliary sound can also be heard using headphones by connecting the headphones 21 to the acoustic output terminal 14 of the acoustic output device 30 instead of the ultrasound speaker 22.

Moreover, in the acoustic output device 30 according to the present embodiment, the audible-bandwidth speakers 20 are connected to the acoustic decoder 48 by means of the acoustic output terminal 49, but may instead be connected to the output terminal of the oversampler 11, which is included in the acoustic processor 10b, by means of the acoustic output terminal 49. In other words, the output signal from the oversampler 11 included in the acoustic processor 10b may alternatively be inputted into the adder 13, and also inputted into the acoustic output terminal 49. Because the output signal from the oversampler 11 included in the acoustic processor 10b is thereby inputted into the audible-bandwidth speakers 20 so as to pass through the acoustic output terminal 49, the main sound is emitted from the audible-bandwidth speakers 20 in a similar or identical manner to Embodiment 2.

The acoustic processor and the acoustic output device according to the present disclosure have been explained above based on Embodiment 1, Variations 1 through 3 thereof, and Embodiment 2, but the present disclosure is not limited to these preferred embodiments and variations. Various kinds of modifications that any person skilled in the art may arrive at and different configurations that are constructed by combining some components of the preferred embodiments and variations that may be applied to the present embodiment and variations are also included within the scope of the present disclosure provided that they do not deviate from the purpose of the present disclosure.

If, for example, equipment that incorporates the acoustic processor according to Embodiment 1, or the acoustic output device according to Embodiment 2, is equipment compatible with high-resolution audio that has been developed and commercialized in recent years, then an acoustic output terminal that outputs a high-resolution audio signal is included, and the acoustic output terminal 14 in the above embodiments and variations may also be used with such acoustic output terminals that are compatible with high-resolution audio equipment. That is because the capacity to reproduce signals of 96 kHz or 192 kHz is included in high-resolution audio standards.

Furthermore, while the acoustic output device 30 according to Embodiment 2 above includes an acoustic processor 10b according to Variation 2 according to Embodiment 1, it may alternatively include the acoustic processor 10 according to Embodiment 1, the acoustic processor 10a according to Variation 1 of Embodiment 1, the acoustic processor 10c according to Variation 3 of Embodiment 1, or an acoustic processor that is achieved by a combination of the components thereof instead of the acoustic processor 10b.

In Embodiment 1 above, the output signal from the oversampler 11 and the output signal from the modulator 12 are both signals that have a sampling frequency Fs of 192 kHz, but it is not absolutely necessary for them to be signals that have an identical sampling frequency Fs. If the sampling frequency Fs of these two output signals is different, then the adder 13 should interpolate the output signal of the one having a lower sampling frequency Fs, etc., to align the sampling frequencies Fs, and then add the two output signals.

### INDUSTRIAL APPLICABILITY

Because the present disclosure is an acoustic processor that processes an acoustic signal and an acoustic output device that outputs sound, and in particular can reproduce conventional sound and an ultrasound signal that is imparted with directivity simultaneously, it can be used in television sets, for example, or playback equipment for DVDs, BDs, etc.

1. An acoustic processor, comprising:
an oversampler that oversamples an acoustic signal that is a digital signal including a frequency component less than or equal to Fh, where Fh is a preset frequency, and having a sampling frequency of Fs, into a signal having a sampling frequency greater than or equal to 2Fs;
a modulator that modulates an ultrasound signal having a frequency Fc greater than or equal to 2Fh as a carrier wave using the acoustic signal;
an acoustic output terminal; and
a selector that selects at least one signal from an output signal from the oversampler or an output signal from the modulator, and outputs the at least one signal selected, to the acoustic output terminal.

2. The acoustic processor according to claim 1, wherein the selector is a switch that selects one signal from the output signal from the oversampler and the output signal from the modulator, and outputs the one signal to the acoustic output terminal.

3. The acoustic processor according to claim 1, wherein the selector is an adder that adds the output signal from the oversampler and the output signal from the modulator, and outputs a resultant sum to the acoustic output terminal.

4. The acoustic processor according to claim 1, wherein the modulator modulates the ultrasound signal using the output signal from the oversampler as the acoustic signal.

5. The acoustic processor according to claim 1, wherein:
the acoustic signal includes a first acoustic signal and a second acoustic signal;
the oversampler oversamples the first acoustic signal into the signal having a sampling frequency greater than or equal to 2Fs; and
the modulator modulates the ultrasound signal having a frequency Fc greater than or equal to 2Fh as a carrier wave using the second acoustic signal.

6. The acoustic processor according to claim 1, wherein Fh is a value greater than or equal to 14 kHz and less than or equal to 24 kHz.

7. An acoustic output device, comprising:
an audible-bandwidth speaker that outputs audible-bandwidth sound vertically; and
an ultrasound speaker that outputs sound horizontally using ultrasonic waves.

8. The acoustic output device according to claim 7, further comprising:
an oversampler that oversamples an acoustic signal that is a digital signal including a frequency component less than or equal to Fh, where Fh is a preset frequency, and having a sampling frequency of Fs, into a signal having a sampling frequency greater than or equal to 2Fs, and outputs the signal oversampled, to the audible-bandwidth speaker; and
a modulator that modulates an ultrasound signal having a frequency Fc greater than or equal to 2Fh as a carrier wave using the acoustic signal, and outputs the ultrasound signal modulated, to the ultrasound speaker.

9. The acoustic output device according to claim 7, further comprising:
an acoustic signal obtainer that obtains an acoustic signal that is a digital signal including a frequency component less than or equal to Fh, where Fh is a preset frequency, and having a sampling frequency of Fs; and
an acoustic processor according to any one of claim 1 that processes the acoustic signal that is obtained by the acoustic signal obtainer as an input,
wherein the audible-bandwidth speaker is connected to the acoustic signal obtainer so as to input the acoustic signal that is obtained by the acoustic signal obtainer to the audible-bandwidth speaker, and
the ultrasound speaker is connected to the acoustic processor so as to input an output signal from a selector of the acoustic processor to the ultrasound speaker.
